(19) United States
(12) Patent Application Publication
(10) Pub. No.: US 2012/0222418 A1
(43) Pub. Date: Sep. 6, 2012

(54) INTERNAL COMBUSTION ENGINE SYSTEM

(75) Inventor: Junji WATANABE, Toyota-shi (JP)

(73) Assignee: TOYOTA JIDOSHA KABUSHIKI KAISHA, Toyota-shi (JP)

(21) Appl. No.: 13/404,595

(22) Filed: Feb. 24, 2012

(30) Foreign Application Priority Data
Mar. 2, 2011 (JP) 2011-044611

(51) Int. Cl. F02B 37/18; F02B 37/00

(52) U.S. Cl. 60/602

(57) ABSTRACT

An internal combustion engine system includes: a turbine disposed in an exhaust passage; a bypass passage provided in the exhaust passage and bypassing the turbine; a wastegate valve that opens and closes the bypass passage; and an air-fuel ratio sensor provided downstream of a discharge port of the bypass passage. The air-fuel ratio sensor is provided at such a position that the proportion of the amount of exhaust gas that directly strikes the air-fuel ratio sensor to the amount of exhaust gas discharged from the bypass passage changes depending on the opening degree of the wastegate valve. When the engine is in a cold-start state, the proportion of the amount of exhaust gas that directly strikes the air-fuel ratio sensor after being discharged from the bypass passage to the amount of exhaust gas discharged from the bypass passage is made smaller than when the engine is in a warm-start state.

### INCORPORATION BY REFERENCE

The disclosure of Japanese Patent Application No. 2011-044611 filed on Mar. 2, 2011 including the specification, drawings and abstract is incorporated herein by reference in its entirety.

### BACKGROUND OF THE INVENTION

1. Field of the Invention

The invention relates to an internal combustion engine system. In particular, the invention relates to an internal combustion engine system that includes a turbocharger.

2. Description of Related Art

A turbocharger is known as an apparatus for increasing the output of an internal combustion engine for use in a motor vehicle. In the turbocharger, a turbine is driven by exhaust gas from the internal combustion engine and intake air is compressed by a compressor connected to the turbine and provided in an intake passage. In a known internal combustion engine equipped with a turbocharger, there are provided a bypass passage that allows a portion of exhaust gas to bypass a turbine and a wastegate valve that opens and closes the bypass passage, in order to prevent excessive rise of the intake pressure due to increase in the pressure of exhaust gas.

In addition, an exhaust passage of the internal combustion engine is provided with an air-fuel ratio sensor that measures the oxygen concentration in exhaust gas. By changing the fuel injection amount according to results output from the air-fuel ratio sensor, it is possible to operate the engine in a manner suitable to improve fuel economy and reduce exhaust emission.

In the case where an air-fuel ratio sensor is provided for an internal combustion engine that is equipped with the turbocharger as described above, the provision of the air-fuel ratio sensor upstream of the turbine requires the air-fuel ratio sensor to have high heat resistance because the temperature of exhaust gas is high. Further, with a so-called twin-scroll turbo provided with a plurality of exhaust passages from combustion chambers to a turbine, a plurality of air-fuel ratio sensors is needed, and therefore a high cost results.

Therefore, if an air-fuel ratio sensor is provided for an internal combustion engine equipped with a turbocharger, it is desirable to provide the air-fuel ratio sensor downstream of a turbine. However, in the case where the air-fuel ratio sensor is provided downstream of the turbine, the exhaust gas discharged from a combustion chamber is stirred by the turbine before arriving at the air-fuel ratio sensor. Therefore, the time (arrival time) at which exhaust gas discharged from the combustion chamber arrives at the air-fuel ratio sensor is difficult to estimate.

If the estimation of the arrival time is not accurate, it sometimes happens that the accuracy of the detection of abnormality of the air-fuel ratio sensor declines or that the accuracy of the detection of air-fuel ratio imbalance among a plurality of cylinders of the internal combustion engine declines. For example, in the detection of abnormality of the air-fuel ratio sensor, the fuel injection amount is controlled such that the air-fuel ratio is intentionally made rich or lean, and the presence or absence of abnormality of the air-fuel ratio sensor is detected on the basis of whether or not the sensor correctly shows the rich or lean air-fuel ratio when the exhaust gas arrives at the air-fuel ratio sensor.

In the detection of air-fuel ratio imbalance among cylinders, it is specifically determined which one of the combustion chambers of the cylinders discharged the exhaust gas whose air-fuel ratio value has just been detected by the air-fuel ratio sensor, and variations in the air-fuel ratio among the cylinders are detected. Therefore, the time at which the exhaust gas discharged from a combustion chamber arrives at the air-fuel ratio sensor needs to be estimated with high accuracy. Japanese Patent Application Publication No. 2009-287409 (JP 2009-287409 A) describes a technology in which an air-fuel ratio sensor is provided downstream of a discharge port of a bypass passage and in which when the abnormality detection for the air-fuel ratio sensor is needed, a wastegate valve is opened, so that the exhaust gas discharged from the bypass passage strikes the air-fuel ratio sensor and therefore the accuracy of the abnormality detection increases.

In order to more accurately perform the abnormality detection for an air-fuel ratio sensor or the detection of inter-cylinder imbalance by monitoring the exhaust gas discharged from a bypass passage, it is preferable to provide the air-fuel ratio sensor at such a position that the exhaust gas discharged from the bypass passage directly strikes the air-fuel ratio sensor, as described in Japanese Patent Application Publication No. 2008-208740 (JP 2008-208740 A).

However, at the time of cold start of an internal combustion engine, it sometimes happens that moisture contained in exhaust gas cools and condenses in a bypass passage and the condensed water is discharged together with the exhaust gas. If this happens in a construction as described above in which the exhaust gas discharged from the bypass passage directly strikes the air-fuel ratio sensor, there is a possibility that the air-fuel ratio sensor will become wet and problems, such as degradation of the sensitivity of the sensor, and the like, will arise.

### SUMMARY OF THE INVENTION

The invention provides an internal combustion engine system capable of suppressing the wetting of an air-fuel ratio sensor while securing sufficient accuracy in the measurement of the air-fuel ratio.

A first aspect of the invention relates to an internal combustion engine system. The internal combustion engine system includes: a turbocharger that has a turbine that is disposed in an exhaust passage of an internal combustion engine; a bypass passage that is provided in the exhaust passage and that bypasses the turbine; a wastegate valve that opens and closes the bypass passage; and an air-fuel ratio sensor disposed on a downstream side of a discharge port of the bypass passage. The air-fuel ratio sensor is provided at such a position that a proportion of an amount of exhaust gas that directly strikes the air-fuel ratio sensor after being discharged from the bypass passage to an amount of exhaust gas discharged from the bypass passage changes depending on a degree of opening of the wastegate valve. When the internal combustion engine is in a cold-start state, the proportion of the amount of exhaust gas that directly strikes the air-fuel ratio sensor after being discharged from the bypass passage to the amount of exhaust gas discharged from the bypass passage is smaller than when the internal combustion engine is in a warm-start state.

A second aspect of the invention relates to a control method for an internal combustion engine system. The internal combustion engine system includes: a turbocharger that has a turbine that is disposed in an exhaust passage of an internal combustion engine; a bypass passage that is provided in the exhaust passage and that bypasses the turbine; a wastegate valve that opens and closes the bypass passage; and an air-fuel ratio sensor provided on a downstream side of a discharge port of the bypass passage. According to the control method, a proportion of an amount of exhaust gas that directly strikes the air-fuel ratio sensor after being discharged from the discharge port to an amount of exhaust gas discharged from the discharge port is changed depending on a degree of opening of the wastegate valve. When the internal combustion engine is in a cold-start state, the proportion of the amount of exhaust gas that directly strikes the air-fuel ratio sensor after being discharged from the discharge port of the bypass passage to the amount of exhaust gas discharged from the discharge port of the bypass passage is made smaller than when the internal combustion engine is in a warm-start state.

With the internal combustion engine system according to the first aspect of the invention and the internal combustion engine system control method according to the second aspect of the invention, the proportion of the amount of exhaust gas that directly strikes the air-fuel ratio sensor after being discharged from the bypass passage to the amount of exhaust gas discharged from the bypass passage is smaller at the time of cold start of the engine than at the time of warm start of the internal combustion engine. Therefore, at the time of cold start of the engine, at which a large amount of condensed water is produced, the amount of gas from the bypass passage which has a large water content and which directly strikes the air-fuel ratio sensor decreases, so that the wetting of the air-fuel ratio sensor is suppressed. In addition, at the time of warm start of the engine, the abnormality detection for the air-fuel ratio sensor and the inter-cylinder air-fuel ratio imbalance detection are performed with high accuracy, by increasing the proportion of the amount of exhaust gas that directly strikes the air-fuel ratio sensor after being discharged from the bypass passage to the amount of exhaust gas discharged from the bypass passage.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing an intake-exhaust system of an internal combustion engine according to an embodiment of the invention;

FIG. 2 is an enlarged view of a portion A in the embodiment of the invention shown in FIG. 1;

FIG. 3 is an enlarged view of the portion A in the embodiment of the invention shown in FIG. 1;

FIG. 4 is a flowchart showing a control of the degree of opening of a wastegate valve in the embodiment of the invention; and

FIG. 5 is a flowchart showing an inter-cylinder air-fuel ratio imbalance detection control in the embodiment of the invention.

### DETAILED DESCRIPTION OF EMBODIMENTS

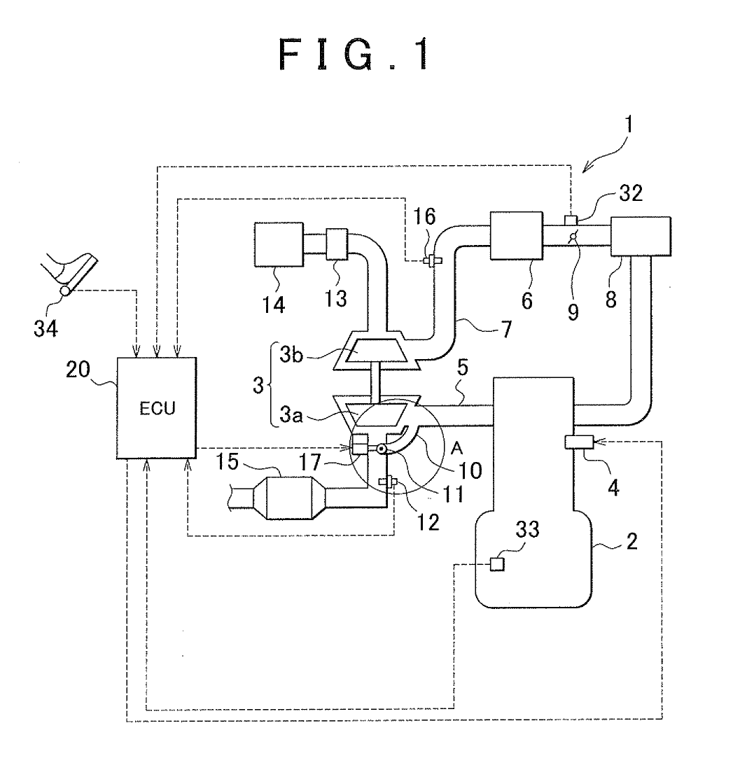

With reference to FIG. 1, an intake-exhaust system of an internal combustion engine according to an embodiment of the invention will be described. In a turbocharged engine 1 in the embodiment, an intake passage 7 and an exhaust passage 5 are connected to an engine body 2. The intake passage 7 is provided with an air cleaner 14, an airflow meter 13, a compressor 3b of a turbocharger 3, a boost pressure sensor 16, an intercooler 6, a throttle 9, a throttle opening degree sensor 32, and a surge tank 8. The exhaust passage 5 is provided with a turbine 3a of the turbocharger 3, a bypass passage 10, a wastegate valve 11, an air-fuel ratio sensor 12, and a catalyst 15.

The air cleaner 14 includes a filter that removes extraneous substances from intake air. The intake air that has passes through the air cleaner 14 is pressurized by the compressor 3b. The boost pressure at this time is detected by the boost pressure sensor 16. The boost pressure sensor 16 may be provided by using, for example, a piezoelectric element.

Because the intake air pressurized by the compressor 3b increases in temperature, the pressurized intake air is cooled by the intercooler 6 that is provided on the intake passage 7. The thus-pressurized intake air is sucked into a plurality of combustion chambers formed in the engine body 2, through intake ports of the engine main body 2, via the throttle 9 and the surge tank 8.

The engine body 2 is provided with a coolant temperature sensor 4 that detects the temperature of the engine coolant, a crank angle sensor 33 that detects the engine speed, etc.

Exhaust gas discharged from the engine body 2 is discharged into the exhaust passage 5 via exhaust ports of the engine body 2. The turbine 3a of the turbocharger 3 is provided in the exhaust passage 5, and the turbine 3a is rotated by exhaust gas.

In addition, the exhaust passage 5 is provided with the bypass passage 10 that bypasses the turbine 3a. The wastegate valve 11 is provided at a junction point where the bypass passage 10 re-joins the exhaust passage 5. The wastegate valve 11 is actuated by an electric actuator 17. The opening degree of the wastegate valve 11 is adjusted to adjust the flow rate of exhaust gas that flows through the turbine 3a and the discharge direction in which the exhaust gas is discharged from the bypass passage 10. The air-fuel ratio sensor 12 is provided downstream of a discharge port of the bypass passage 10. The air-fuel ratio sensor 12 is, for example, a sensor that includes a sheet-shaped solid electrolyte element made of an oxygen ion conductive material, such as zirconia, and a pair of electrodes that sandwich the solid electrolyte element. The air-fuel ratio sensor 12 outputs a voltage that corresponds to the oxygen concentration in exhaust gas.

In this embodiment, by measuring the oxygen concentration in exhaust gas through the use of the air-fuel ratio sensor 12, variations in the air-fuel ratio among the combustion chambers of the engine body 2 are detected (i.e., so-called inter-cylinder imbalance detection is performed). More specifically, the arrival time at which the exhaust gas discharged from each one of the combustion chambers arrives at the air-fuel ratio sensor 12 is estimated, and the air-fuel ratios in the respective combustion chambers, calculated based on the values detected by the air-fuel ratio sensor 12 at the estimated arrival times, are compared with each other.

In this embodiment, the engine 1 is provided in a vehicle (not shown). Downstream of the air-fuel ratio sensor 12, there are provided the catalyst 15, a silencer, etc. (not shown). Exhaust gas is discharged out of the vehicle, via these components. An ECU 20 includes a CPU, a ROM, a RAM, and a data bus that interconnects those components. According to programs stored in the ROM, the ECU 20 performs, for example, a control of the degree of opening of the wastegate valve 11 described below. Further, the ECU 20 is electrically connected to various sensors of the vehicle, and receives values detected by the sensors. The sensors include an accelerator pedal position sensor 34, an outside air temperature sensor, a vehicle speed sensor, etc., in addition to the aforementioned sensors.

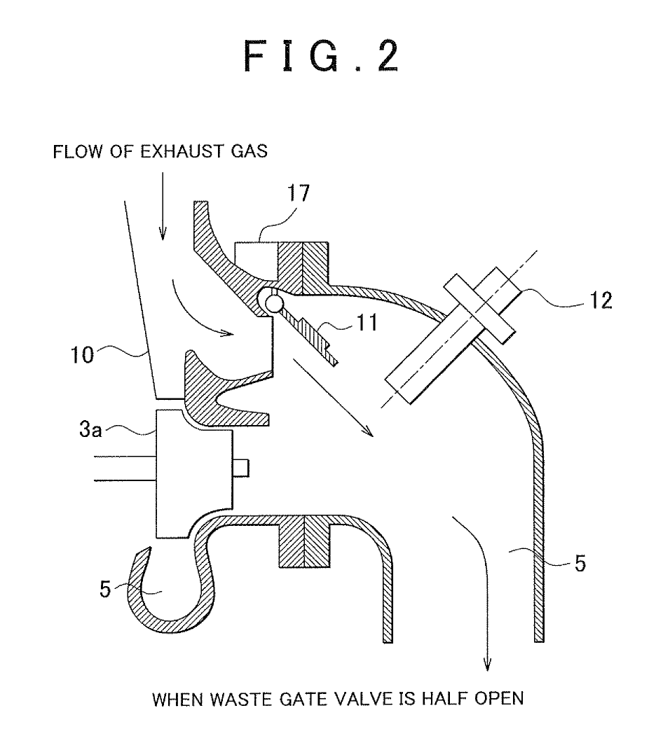

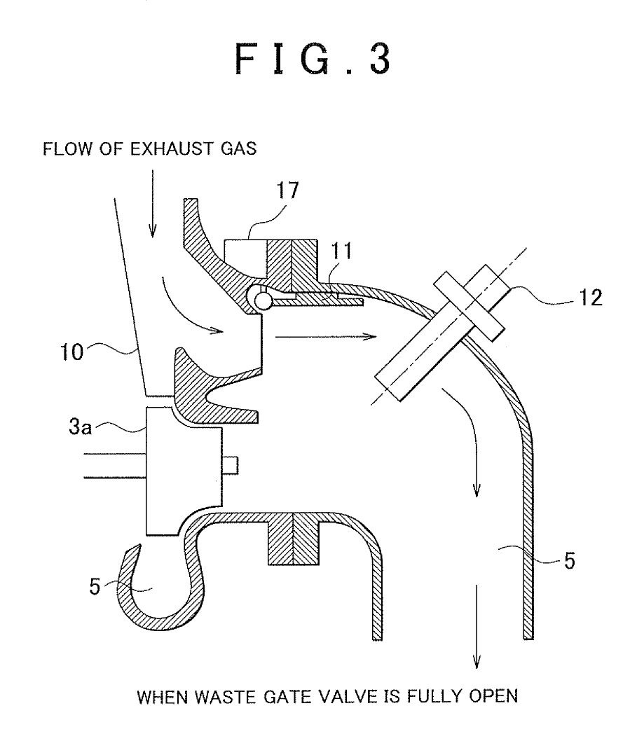

Next, a construction at and around a junction point between the exhaust passage 5 and the bypass passage 10 will be described in detail with reference to FIGS. 2 and 3, which show enlarged views of a portion A shown in FIG. 1.

As shown in FIG. 2 and FIG. 3, the bypass passage 10 and the exhaust passage 5 join at the junction point downstream of the turbine 3a. The bypass passage 10 is opened and closed by the wastegate valve 11 that is provided at the junction point. The opening degree of the wastegate valve 11 is determined according to the conditions of operation of the engine 1 based on values detected by the boost pressure sensor 16 and the crank angle sensor 33, etc. For example, at the time of starting the engine 1 or during the idling of the engine 1, the wastegate valve 11 is opened to maintain the bed temperature of the catalyst 15. On the other hand, when large boost pressure is needed, for example, during acceleration of the vehicle, the wastegate valve 11 is closed. In this embodiment, the wastegate valve 11 is pivoted in the range of angle between 0 degrees (completely closed) and 90 degrees (fully opened) about a support point, whereby the flow rate of the exhaust gas that passes through the turbine 3a and the discharge direction in which the exhaust gas is discharged from the bypass passage 10 are controlled. In particular, the flow rate of the exhaust gas that passes through the turbine 3a is adjusted by adjusting the opening degree of the wastegate valve 11 between 0 degree and 45 degrees in angle. When the opening degree of the wastegate valve 11 is greater than or equal to 45 degree, most of the exhaust gas flows into the bypass passage 10, irrespective of the opening degree. Specifically, when the opening degree of the wastegate valve 11 is greater than or equal to a predetermined degree, the rotation speed of the turbine 3a is constant, irrespective of the opening degree of the wastegate valve 11. Note that, FIG. 2 shows a state in which the opening degree of the wastegate valve 11 is 45 degrees in angle (a half open state) that is a first opening degree, and FIG. 3 shows a state in which the opening degree of the wastegate valve 11 is 90 degrees in angle (a fully open state) that is a second opening degree.

The air-fuel ratio sensor 12 is provided at a position that is downstream of the discharge port of the bypass passage 10 and that is on an extension'of the bypass passage 10. Further, the air-fuel ratio sensor 12 is provided so as to protrude into the exhaust passage 5 from a side where the support point of the wastegate valve 11 is provided. When the opening degree of the wastegate valve 11 is the first opening degree that is small as shown in FIG. 2, the discharge port of the bypass passage 10 and the air-fuel ratio sensor 12 are positioned on the opposite sides of the wastegate valve 11. Therefore, the exhaust gas discharged from the bypass passage 10 flows along a reverse surface of the wastegate valve 11 as shown in FIG. 2, so that the proportion of the amount of exhaust gas that directly strikes the air-fuel ratio sensor 12 after being discharged from the bypass passage 10 to the amount of exhaust gas that is discharged from the bypass passage 10 is small.

On the other hand, when the wastegate valve 11 is fully opened or substantially fully opened (when the opening degree of the wastegate valve 11 is at or near the second opening degree), the wastegate valve 11 is not located between the discharge port of the bypass passage 10 and the air-fuel ratio sensor 12. Therefore, the exhaust gas discharged from the bypass passage 10 flows in the direction of extension of the bypass passage 10, and most of the exhaust gas discharged from the bypass passage 10 directly strikes the air-fuel ratio sensor 12.

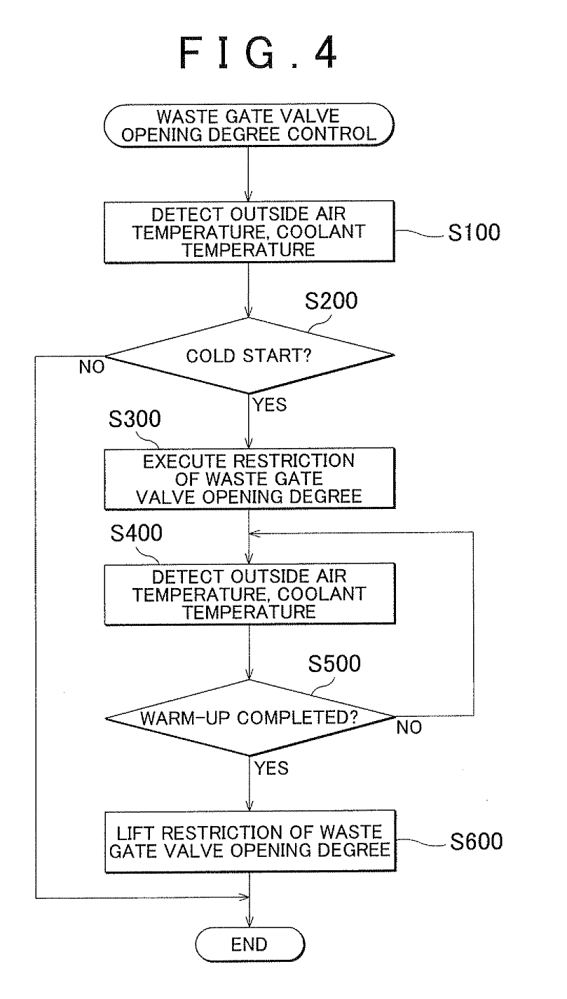

Thus, in this embodiment, by controlling the opening degree of the wastegate valve 11, it is possible to change the discharge direction of exhaust gas, and to change the proportion of the amount of exhaust gas that directly strikes the air-fuel ratio sensor 12 after being discharged from the bypass passage 10 to the amount of exhaust gas discharged from the bypass passage 10. Next, a control of the opening degree of the wastegate valve 11 in this embodiment will be described with reference to FIG. 4.

When the engine 1 is started, the ECU 20 detects the outside air temperature and the coolant temperature (S100) by using the outside air temperature sensor and the coolant temperature sensor 4, respectively. Then, on the basis of the detected temperatures, the ECU 20 determines whether the engine 1 is in a cold start state (S200). If the engine 1 is not in the cold start state (NO in S200), the process proceeds to a normal control in which the wastegate valve 11 is opened and closed according to the conditions of operation of the engine. That is, the wastegate valve 11 is allowed to open to 90 degrees in angle, which is the second opening degree, so that the warm-up of the air-fuel ratio sensor 12, and the like, is performed.

On the other hand, if it is determined that the engine 1 is in the cold start state (YES in S200), the process proceeds to S300, in which the maximum opening degree of the wastegate valve 11 is restricted to 50% of opening degree in the fully open state (i.e., to the first opening degree) or less. Concretely, a guard value for the opening degree of the wastegate valve 11 is provided so that even when the degree of opening of the wastegate valve 11 would be set to a value greater than 50% according to the conditions of operation of the engine 1 in the normal control, the opening degree of the wastegate valve 11 is restricted to 50%. After that, the ECU 20 detects the outside air temperature and the coolant temperature by using the outside air temperature sensor and the coolant temperature sensor 4, respectively, again (S400). On the basis of the detected temperatures, the ECU 20 determines whether the warm-up of the engine I has been completed (S500). If it is determined that the warm-up of the engine 1 has not been completed (NO in S500), the process returns to S400, and therefore the restriction of the maximum opening degree is continued. On the other hand, if it is determined that the warm-up of the engine 1 has been completed, the ECU 20 lifts the restriction on the maximum opening degree (S600), and proceeds to the normal control in which the wastegate valve 11 is opened and closed according to the conditions of operation of the engine 1.

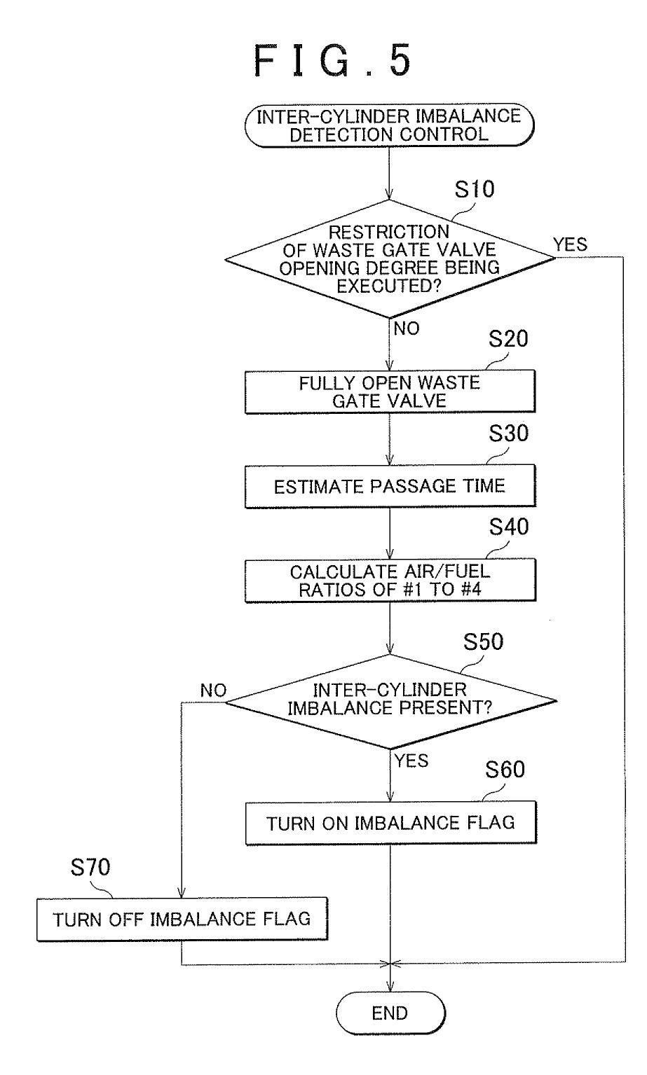

Next, the inter-cylinder imbalance detection control performed in this embodiment will be described with reference to FIG. 5. When the inter-cylinder imbalance detection control starts, it is firstly determined in S10 whether the restriction on the opening degree of the wastegate valve 11 is being executed. If the restriction on the opening degree of the wastegate valve 11 is being executed (YES in S10), the ECU 20 determines that it is not possible to perform the inter-cylinder imbalance detection, and then ends the control.

On the other hand, if the restriction on the opening degree of the wastegate valve 11 is not being executed (NO in S10), the ECU 20 determines that it is possible to perform the inter-cylinder imbalance detection, and then proceeds to S20. In S20, the ECU 20 sets the opening degree of the wastegate valve 11 to the full-open degree in order to improve the accuracy of the inter-cylinder imbalance detection.

In S30, using the value detected by the airflow meter 13, the value detected by the boost pressure sensor 16, the value detected by the throttle opening degree sensor 32, and the engine speed obtained from the value detected by the crank angle sensor 33, etc., the ECU 20 estimates the time (arrival time) at which the exhaust gas discharged from each one of the combustion chambers (#1 to #4) of the engine body 2 reaches the air-fuel ratio sensor 12.

In S40, the ECU 20 reads the value detected by the air-fuel ratio sensor 12 at each of the arrival times estimated in S30, and calculates the air-fuel ratio in each of the combustion chambers (#1 to #4). In S50, the ECU 20 compares the air-fuel ratios in the respective combustion chambers (#1 to #4) and determines whether there is inter-cylinder imbalance in the air-fuel ratio. According to the result of the determination, the ECU 20 turns an imbalance flag on or off (S60 or S70), and then ends this process.

With an internal combustion engine system according to the embodiment, the following operation and effects are achieved.

(1) In this embodiment, the bypass passage 10, the wastegate valve 11 and the air-fuel ratio sensor 12 are disposed such that the proportion of the amount of exhaust gas that directly strikes the air-fuel ratio sensor 12 after being discharged from the bypass passage 10 to the amount of exhaust gas discharged from the bypass passage 10 is controlled by controlling the opening degree of the wastegate valve 11. Therefore, through the control of the opening degree of the wastegate valve 11, the wetting of the air-fuel ratio sensor 12 is suppressed, and when the air-fuel ratio needs to be accurately detected, exhaust gas is caused to directly strike the air-fuel ratio sensor 12.

(2) In this embodiment, the opening degree of the wastegate valve 11 is controlled such that the proportion of the amount of exhaust gas that directly strikes the air-fuel ratio sensor 12 after being discharged from the bypass passage 10 to the amount of exhaust gas discharged from the bypass passage 10 is smaller at the time of cold start of the engine than at the time of warm start of the engine. Therefore, at the time of cold start of the engine, at which condensed water is likely to be produced, it is possible to reduce the proportion of the exhaust gas that directly strikes the air-fuel ratio sensor 12 and therefore suppress the wetting of the air-fuel ratio sensor 12.

(3) In this embodiment, the opening degree of the wastegate valve 11 is adjusted to the first opening degree when the engine is in the cold start state, and to the second opening degree when the engine is in the warm start state. Therefore, at the time of cold start of the engine, the wetting of the air-fuel ratio sensor 12 is suppressed, while at the time of warm start of the engine, the warm-up of the catalyst 15 and the warm-up of the air-fuel ratio sensor 12 are promoted.

(4) In the embodiment, when the opening degree of the wastegate valve 11 is the first opening degree, which is relatively small, the discharge port of the bypass passage 10 and the air-fuel ratio sensor 12 are on the opposite sides of the wastegate vale 11, and when the wastegate valve 11 is fully open or substantially fully open (when the opening degree of the wastegate valve 11 is at or near the second opening degree), the wastegate valve 11 is not positioned between the discharge port of the bypass passage 10 and the air-fuel ratio sensor 12. Therefore, by adjusting the opening degree of the wastegate vale 11, the proportion of the amount of exhaust gas that directly strikes the air-fuel ratio sensor 12 is changed.

(5) In this embodiment, the inter-cylinder imbalance in the air-fuel ratio is detected by using the air-fuel ratio sensor 12. In order to accurately detect the inter-cylinder imbalance, it is required that the time at which the exhaust gas discharged from each combustion chamber arrives at the air-fuel ratio sensor 12 be accurately estimated. However, the time at which the exhaust gas that passes through the turbocharger 3 arrives at the air-fuel ratio sensor 12 is difficult to estimate because the time varies depending on the rotation speed of the turbine 3a. Therefore, the exhaust gas discharged from the bypass passage 11 is caused to strike the air-fuel ratio sensor 12, so that the inter-cylinder imbalance is detected with high accuracy.

(6) In this embodiment, when the restriction on the opening degree of the wastegate valve 11 is being executed, execution of the inter-cylinder air-fuel ratio imbalance detection is avoided. Because the inter-cylinder air-fuel ratio imbalance detection is avoided when the detection accuracy of the air-fuel ratio sensor 12 has been reduced, the detection accuracy of the inter-cylinder imbalance is improved, and false detection is suppressed.

(7) In this embodiment, when the opening degree of the wastegate valve 11 is greater than or equal to a predetermined opening degree, the flow rate of exhaust gas that passes through the turbine 3a is prevented from changing. That is, when the opening degree of the wastegate valve 11 is greater than or equal to the predetermined opening degree, only the discharge direction in which exhaust gas is discharged from the bypass passage 10 is changed. Therefore, at the time of start of the engine, by minimizing the amount of exhaust gas that flow into the turbine 3a, it is possible to suitably achieve one of promotion of the warm-up of the catalyst 15 through the use of the exhaust gas that passes through the bypass passage 10 and suppression of the wetting of the air-fuel ratio sensor 12, according to whether the start of the engine is cold start or warm start.

Note that, the internal combustion engine system according to this embodiment may be implemented in the following modes.

Although in the foregoing embodiment, the bypass passage 10 is opened and closed by adjusting the opening degree of the wastegate valve 11 in the range of 0 degree to 90 degrees in angle, this example does not limit the manner of operation of the wastegate valve 11. The wastegate valve 11 may be operated in any manner as long as the opening degree of the wastegate valve 11 is changed so as to change the flow rate of exhaust gas flowing through the bypass passage 10 according to the conditions of operation of the engine 1.

Although in the foregoing embodiment, the opening degree of the wastegate valve 11 in the half open state is defined as the first opening degree, and the opening degree of the wastegate valve 11 in the fully open state is defined as the second opening degree, the invention is not limited to this. For example, the discharge port of the bypass passage 10, the wastegate valve 11 and the air-fuel ratio sensor 12 may also be disposed such that the aforementioned relation in the opening degree is inverted, or each of the first opening degree and the second opening degree may have a range.

In the embodiment, the guard value is provided as a technique for restricting the opening degree of the wastegate valve 11. However, this example does not limit the technique for restricting the opening degree of the wastegate valve 11. For example, the opening degree of the wastegate valve 11 may also be restricted by multiplying the opening degree of the wastegate valve 11 determined by the conditions of operation of the engine 1 by a predetermined gain.

In the foregoing embodiment, it is determined in S500 whether the warm-up of the engine 1 has been completed on the basis of the coolant temperature in the engine body 2 detected by the coolant temperature sensor 4. However, this does not limit the condition for lifting the restriction on the opening degree of the wastegate valve 11. For example, the time that it takes for the amount of condensed water to decrease to or below a predetermined amount may be estimated from the fuel injection amount, the engine speed, etc., and the restriction on the opening degree of the wastegate valve 11 may be lifted after the estimated time elapses.

Although in the embodiment, the inter-cylinder imbalance detection is performed by using the air-fuel ratio sensor 12, the scope of application of the invention is not limited to the internal combustions in which the inter-cylinder imbalance detection is performed. The invention may also be applied to an engine in which the fuel injection amount is changed according to the output of the air-fuel ratio sensor 11.

In the embodiment, the flow rate of exhaust gas directed to the turbine 3a is changed with changes in the opening degree of the wastegate valve 11 when the opening degree is less than the opening degree in the half open state, and only the discharge direction in which exhaust gas is discharged from the bypass passage is changed when the opening degree is equal to or greater than the opening degree in the half open state. However, this does not limit the flow control that is based on the opening degree of the wastegate valve 11. For example, the flow rate of exhaust gas directed to the turbine 3a may be changed throughout the entire region of the opening degree control of the wastegate valve 11.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. An internal combustion engine system comprising:
a turbocharger that has a turbine that is disposed in an exhaust passage of an internal combustion engine;
a bypass passage that is provided in the exhaust passage and that bypasses the turbine;
a wastegate valve that opens and closes the bypass passage; and
an air-fuel ratio sensor disposed on a downstream side of a discharge port of the bypass passage, wherein
the air-fuel ratio sensor is provided at such a position that a proportion of an amount of exhaust gas that directly strikes the air-fuel ratio sensor after being discharged from the bypass passage to an amount of exhaust gas discharged from the bypass passage changes depending on a degree of opening of the wastegate valve, and
when the internal combustion engine is in a cold-start state, the proportion of the amount of exhaust gas that directly strikes the air-fuel ratio sensor after being discharged from the bypass passage to the amount of exhaust gas discharged from the bypass passage is smaller than when the internal combustion engine is in a warm-start state.

2. The internal combustion engine system according to claim 1, wherein:
the wastegate valve is set with a first opening degree, and a second opening degree at which the proportion of the amount of exhaust gas that directly strikes the air-fuel ratio sensor after being discharged from the bypass passage to the amount of exhaust gas discharged from the bypass passage is greater than the proportion at the first opening degree; and
the degree of opening of the wastegate valve is set to the first opening degree when the internal combustion engine is in the cold-start state, and the degree of opening of the wastegate valve is set to the second opening degree when the internal combustion engine is in the warm-start state.

3. The internal combustion engine system according to claim 1, wherein:
the air-fuel ratio sensor is provided at such a position that the proportion of the amount of exhaust gas that directly strikes the air-fuel ratio sensor after being discharged from the bypass passage to the amount of exhaust gas discharged from the bypass passage increases with an increase in the degree of opening of the wastegate valve; and
when the internal combustion engine is in the cold-start state, the degree of opening of the wastegate valve is smaller than when the internal combustion engine is in the warm-start state.

4. The internal combustion engine system according to claim 2, wherein:
when the degree of opening of the wastegate valve is the first opening degree, a discharge port of the bypass passage and the air-fuel ratio sensor are on opposite sides of the wastegate valve; and
when the degree of opening of the wastegate valve is the second opening degree, the wastegate valve is not located between the discharge port of the bypass passage and the air-fuel ratio sensor.

5. The internal combustion engine system according to claim 1, wherein
a maximum degree of opening of the wastegate valve is restricted according to a temperature of a coolant in the internal combustion engine.

6. The internal combustion engine system according to claim 5, wherein
the maximum degree of opening of the wastegate valve is restricted when the internal combustion engine is in the cold-start state.

7. The internal combustion engine system according to claim 1, wherein
the air-fuel ratio sensor is provided on a straight line that extends in a direction of extension of the bypass passage.

8. The internal combustion engine system according to claim 1, wherein:
the internal combustion engine has a plurality of cylinders; and
whether there is variation in air-fuel ratio between the cylinders of the internal combustion engine is detected based on a result output from the air-fuel ratio sensor.

9. The internal combustion engine system according to claim 8, wherein
when the internal combustion engine is in the cold-start state or while a maximum degree of opening of the wastegate valve is restricted, variation in the air-fuel ratio is not detected.

10. The internal combustion engine system according to claim 1, wherein
the degree of opening of the wastegate valve is restricted to a value equal to or smaller than a predetermined degree of opening when a rotation speed of the turbine is constant irrespective of the degree of opening of the wastegate valve and the internal combustion engine is in the cold-start state.

11. A control method for an internal combustion engine system that includes:
a turbocharger that has a turbine that is disposed in an exhaust passage of an internal combustion engine;
a bypass passage that is provided in the exhaust passage and that bypasses the turbine;
a wastegate valve that opens and closes the bypass passage; and
an air-fuel ratio sensor provided on a downstream side of a discharge port of the bypass passage,
the control method comprising
changing a proportion of an amount of exhaust gas that directly strikes the air-fuel ratio sensor after being discharged from the discharge port to an amount of exhaust gas discharged from the discharge port, depending on a degree of opening of the wastegate valve,
wherein when the internal combustion engine is in a cold-start state, the proportion of the amount of exhaust gas that directly strikes the air-fuel ratio sensor after being discharged from the discharge port of the bypass passage to the amount of exhaust gas discharged from the discharge port of the bypass passage is made smaller than when the internal combustion engine is in a warm-start state.
